(19) United States
(12) Patent Application Publication
(10) Pub. No.: US 2026/0316857 A1
(43) Pub. Date: Oct. 15, 2026

(54) TAPERED IDLER WHEEL AND TRACK ASSEMBLY

(71) Applicant: Caterpillar Inc., Peoria, IL (US)

(72) Inventors: Anvesh TIWARI, CHENNAI (TAMIL NADU) (IN); Martin Tagore Joseph XAVIER, Tamil nadu (IN)

(73) Assignee: Caterpillar Inc., Peoria, IL (US)

(21) Appl. No.: 19/178,355

(22) Filed: Apr. 14, 2025

(51) Int. Cl. B62D 55/14; B62D 55/20

(52) U.S. Cl. CPC B62D 55/14; B62D 55/202

(57) ABSTRACT

An idler wheel for a track assembly includes a first end, a second end, opposite to the first end, a first outer portion adjacent to the first end, and a second outer portion adjacent to the second end. The idler wheel also includes an axially inner portion between the first outer portion and the second outer portion, a first tapered surface on the first outer portion that tapers inwardly towards the axially inner portion from the first end, and a second tapered surface, adjacent to the second end, that tapers from the second end toward a center of the axially inner portion.

### TECHNICAL FIELD

The present disclosure relates generally to a track link assembly, and, more particularly, to a tapered idler wheel for a track link assembly.

### BACKGROUND

Each track assembly of a track-type machine, such as a dozer, an excavator, or a skid-steer loader, includes a loop of interconnected track link assemblies and series of track shoes, referred to as a track, that moves or rotates around an idler and roller assembly. The idler and roller assembly includes rollers, or cylindrical wheels, that support the weight of the machine, guide and support the track link assemblies, and are positioned within the loop of track link assemblies. Idler wheels, in particular, help support the weight of the machine and apply tension to the track assembly.

In some arrangements, a single idler wheel may be utilized, while in other arrangements two idler wheels (e.g., a front idler wheel and a rear idler wheel) may be included. The front idler wheel is located toward the front of the track assembly of the machine and prevents the track link assembly from slipping off of the track (also referred to as slippage), during operation of the machine in side-slope applications. The rear idler wheel performs similar functions and is located at the rear of the machine. Idler wheels typically have generally flat, cylindrical surfaces for contacting track links. Idler wheels having this configuration are designed for use with rollers that contain outer flanges, inner flanges, or both, to prevent slippage of the track assembly. These flanges, and the use of structurally-dissimilar rollers, can introduce complexity, impose manufacturing limitations, and increase cost.

U.S. Pat. No. 10,710,653, issued on Jul. 14, 2020 (“the '653 patent”), describes a self-aligning idler wheel design for use with elastomeric tracks. The idler wheel design of the '653 patent has an outer diameter that is greater than an inside diameter of the wheel, the entire central portion of the wheel being inclined. This arrangement places tension on an elastomeric track when the track contacts the inside diameter of the idler wheel, the tension tending to reduce the likelihood of track misalignment. The idler wheels described in the '653 patent are not structured for use with tapered track links or tapered track link assemblies having opposed tapered track links.

The system and method of the present disclosure may solve one or more of the problems set forth above and/or other problems in the art. The scope of the current disclosure, however, is defined by the attached claims, and not by the ability to solve any specific problem.

### SUMMARY

In one aspect, an idler wheel for a track assembly, the idler wheel including a first end, a second end, opposite to the first end, a first outer portion adjacent to the first end, and a second outer portion adjacent to the second end. The idler wheel may also include an axially inner portion between the first outer portion and the second outer portion, a first tapered surface on the first outer portion that tapers inwardly towards the axially inner portion from the first end, and a second tapered surface, adjacent to the second end, that tapers from the second end toward a center of the axially inner portion.

In another aspect, a track assembly, a first track link including: a first end, a second end opposite to the first end, and a first track link tapered surface formed on the second end, a taper of the first track link tapered surface causing a thickness of the first track link to decrease in an outward direction of the first track link. The track assembly may also include an idler wheel including: a first outer face, a central portion, and a first idler tapered surface between the first outer face and the central portion, the first idler tapered surface being configured to contact the first track link tapered surface.

In yet another aspect, a track assembly for a machine may include a first track link having: a flat surface configured to be connected to a track shoe, and a first track link tapered surface opposite to the flat surface, a second track link, and a bushing connecting the first track link and the second track link, the bushing extending along a bushing axis. The track assembly may also include an idler wheel including: a first outer face, a central portion, and a first idler tapered surface between the first outer face and the central portion, the first idler tapered surface forming an angle of about 1° to about 10° with the bushing axis, the first idler tapered surface being configured to contact the first track link tapered surface.

### BRIEF DESCRIPTION OF THE DRAWINGS

FIG. 1 is a perspective view of a dozer, as an example of a track-type machine, having track assemblies, including tapered idler wheels, in accordance with the present disclosure.

FIG. 2 is a perspective view of a tapered idler wheel, as part of a track assembly shown in FIG. 1.

FIG. 3 is a front schematic view of the tapered idler wheel of the track assembly of FIG. 1.

FIG. 4 is a cross-sectional view of the track assembly including multiple track links and a tapered idler wheel according to the carrier roller shown in FIGS. 2 and 3.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion, such that a process, method, article, or apparatus that comprises a list of elements does not include only those elements, but may include other elements not expressly listed or inherent to such a process, method, article, or apparatus. Moreover, in this disclosure, relative terms, such as, for example, “about,” “generally, “substantially,” and “approximately” are used to indicate a possible variation of ±10% in the stated value.

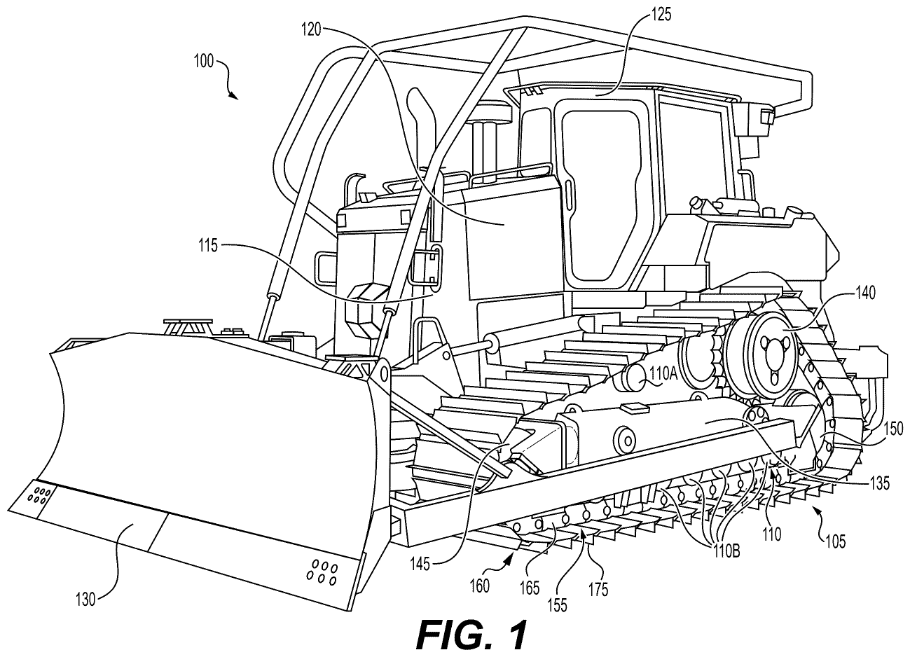

FIG. 1 shows a track-type machine 100 having two track assemblies 105 (only one shown), each track assembly 105 including one or a plurality of tapered idler wheels 145, 150, in accordance with the present disclosure. Machine 100 also includes a machine frame 115 supporting an engine 120 or other power-generating device (e.g., batteries, a fuel cell, a generator set, etc.), an operator station (or cab) 125, a work tool in the form of a blade 130, and a track support frame 135 provided as part of an undercarriage of the machine frame 115.

Each track assembly 105 may include a sprocket 140, a front idler 145, a rear idler 150, track rollers 110, including at least one top carrier roller 110A and bottom track rollers 110B, and a plurality of track link assemblies 155 connected to a track 160. Track link assemblies 155 may form a loop around sprocket 140, front idler 145, rear idler 150, and track rollers 110. Front idler 145 and rear idler 150 may aid in movement of track 160 and help to maintain alignment of track 160 and to maintain proper tension of track 160. Top carrier roller 110A and bottom track rollers 110B also support the weight of track 160 and, with idlers 145 and 150, help to maintain alignment of track 160. Bottom track rollers 110B minimize strain on sprocket 140 and on idlers 145 and 150. Track assemblies 105, work tool 130, sprockets 140, idlers 145 and 150, and the plurality of track rollers 110 are all mounted to and supported by track support frame 135.

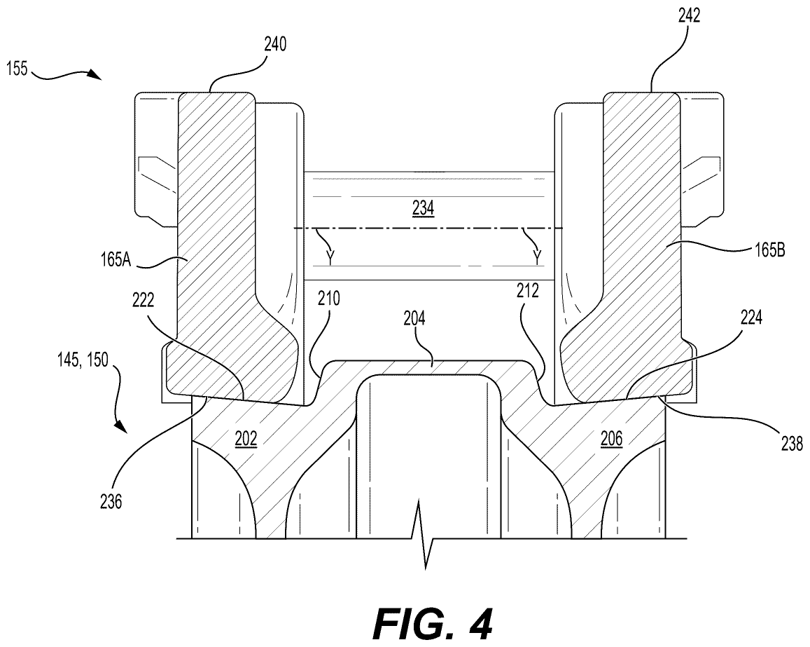

Each track link assembly 155 includes two laterally-opposed tapered track links 165, connected to each other and to adjacent pairs of tapered track links 165 using bushings 234 (FIG. 4) and link pins (not shown). Tapered track links 165 may be connected to track shoes 175 by bolts (not shown) and nuts (not shown) or other suitable fasteners to form track assemblies 105, assemblies 105 each including a respective track 160 formed by a series of track shoes 175. During operation, engine 120 is configured to generate a power output directed through a final drive (e.g., sprocket 140), which transmits a force to move track 160, including each track link assembly 155 and track shoe 175, around idlers 145 and 150 and rollers 110 to propel machine 100 forwards or backwards with engagement of track shoes 175 of a segment of the track 160 with ground material.

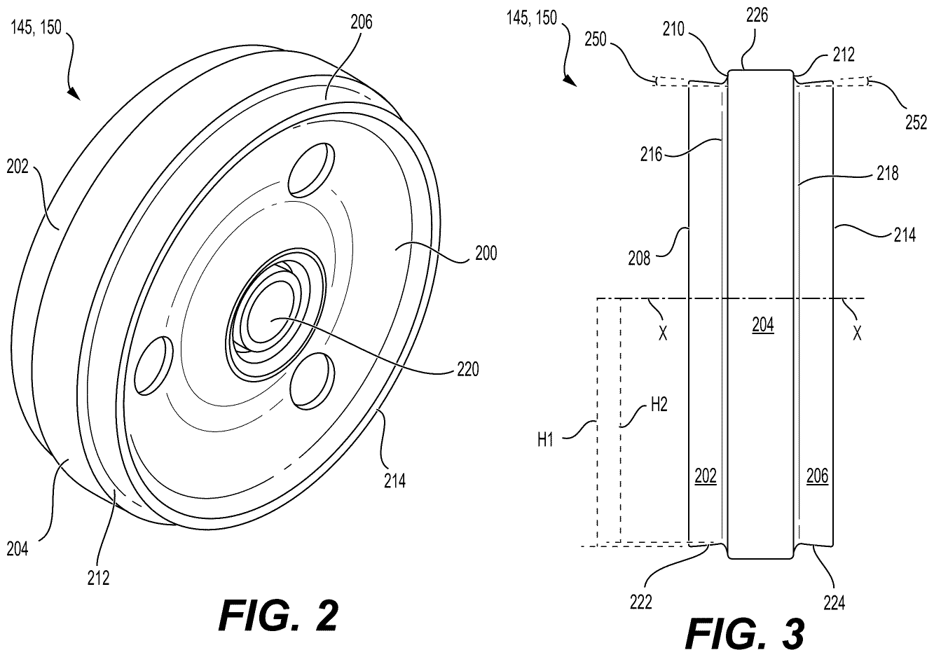

FIG. 2 is a perspective view of a tapered idler wheel 145, 150, which may form part of a track assembly 105, in accordance with the present disclosure, references below being to front idler 145 for brevity. As shown in FIG. 2, front idler 145 may include a first outer contact portion 202, a bridge portion 204, also referred to as a central portion or an axially inner portion, and a second outer contact portion 206. As used herein, “outer,” “outside,” and “outward” refer to directions that face away from the midpoint of front idler 145 (e.g., a center of bridge portion 204 along an axial direction of front idler 145).

Front idler 145 may include a body 200 forming each of first outer contact portion 202, bridge portion 204, and second outer contact portion 206. Outer contact portion 202, bridge portion 204, and outer contact portion 206 may together form an idler shell configured to be connected to seals, collars, bushings, shafts, etc., to connect front idler 145 to other components of track assembly 105. A central opening 220 may be configured to receive a bushing, shaft, and other components (not shown) to connect front idler 145 to track support frame 135 and allow front idler 145 to rotate during movement of machine 100. Outer contact portions 202 and 206 may define an outward-facing first end 208 (FIG. 3) and an outward-facing second end 214 of idler wheel 145.

As shown in FIG. 3, outer contact portion 202 of front idler 145 may include an outer tapered surface 222. Outer tapered surface 222 may extend from first outer end 208 to a first wall 210 of bridge portion 204, an inner tapered end 216 of tapered surface 222 being formed at wall 210. Outer tapered surface 222 may taper, or narrow, in an inward direction from outer face or end 208 toward outer wall 210 (e.g., inwardly along a central axis X-X about which front idler 145 is configured to rotate). As used herein, “inward,” “inner,” and “inside” refer to directions toward the midpoint, measured axially, of front idler 145. Tapered surface 222 may be flat along its entirety, including at inner and outer ends of tapered surface 222, forming a constant angle of inclination corresponding to an angle 250, as described below.

An outer contact portion 206 of idler 145 may include an outer tapered surface 224. Outer tapered surface 224 may extend from second outer end 214 to a second wall 212 of bridge portion 204, an inner tapered end 218 of tapered surface 224 being formed at wall 212. Outer tapered surface 224 may taper in an inward direction from outer end 214 toward outer wall 212. Tapered surface 224 may be flat along its entirety, including at inner and outer ends of tapered surface 224, forming a constant angle of inclination corresponding to an angle 252, as described below.

In one or more embodiments, front idler 145 may be formed of three portions, a first portion including outer contact portion 202, a second portion including bridge portion 204, and a third portion including outer contact portion 206. The first portion, the second portion, and the third portion may be formed as a unitary and integral structure. In other aspects, outer contact portion 202 and outer contact portion 206 may be connected to bridge portion 204 via fastening, for example. Other means of attaching or joining the first portion, second portion, and third portion of front idler 145 may be used. The first portion and the third portion include outer tapered surface 222 and outer tapered surface 224, respectively, with outer tapered surface 222 and tapered surface 224 each being configured for contacting a track link 165 (FIG. 4).

In one or more embodiments, walls 210 and 212 may define a cylindrical portion 226 of front idler 145. Cylindrical portion 226 may define a portion of front idler 145 having a substantially constant diameter or a constant diameter. In some aspects, the height of portion 226 is greater than height H1 and height H2. In other aspects, the height of portion 226 is equal to or less than height H1 and larger than height H2. Walls 210 and 212 of tapered front idler 145 may form raised surfaces that extend from inner ends of outer tapered surface 222 and of outer tapered surface 224.

As shown in FIG. 3, a width of outer contact portion 202 and a width of outer contact portion 206 are equal. The width of outer contact portion 202 may be measured along axis X-X from end 208 to inner tapered end 216. The width of outer contact portion 206 may also be measured along axis X-X and may extend from second outer end 214 to inner tapered end 218. Height H1, forming a largest radius of outer tapered surface 222, may be equal to the maximum height or largest radius of tapered surface 224. Further, in one or more embodiments, the taper formed by outer tapered surface 222 or by tapered surface 224 may be extend linearly along the entirety of the corresponding surface.

A first angle 250 of outer tapered surface 222 relative to axis X-X, or relative to a line parallel to axis X-X as shown in FIG. 3, and a second angle 252 of inner tapered surface 224 relative to the axis X-X or to the same line are equal. One or both of angles 250 and 252 may be about 1° to about 10°, or 2° to about 5°. First angle 250 may be the same when measured at inner tapered end 216 and at end 208. Tapered surfaces 222 and 224 may allow for the omission of flanges outward of portion 204. In particular, idler wheel 145 may be free of flanges between outward-facing end 208 and inner tapered end 216, as well as free of flanges between outward-facing end 214 and tapered end 218 of surface 224.

In other embodiments, one or more of the following may apply: the width of outer contact portion 202 and the width of outer contact portion 206 may be different from each other, first angle 250 and second angle 252 may be different from each other, the taper of outer tapered surface 222 and the taper of tapered surface 224 may be different from each other, or one or both of outer tapered surface 222 and tapered surface 224 may be non-linear, including being partially or entirely curved.

FIG. 4 is a cross-sectional view showing track link assembly 155, including a pair of tapered track links 165, tapered track link 165A and tapered track link 165B, in contact with tapered idler wheel 145. As shown in FIG. 4, a pair of tapered track links 165 may oppose each other for contacting opposite sides of idler wheel 145. The view of FIG. 4 shows a first tapered track link 165A in contact with tapered surface 222 of outer contact portion 202 and a second tapered track link 165B in contact with tapered surface 224 of outer contact portion 206.

First tapered track link 165A may include an upper flat surface 240 that is configured for contacting a track shoe that is fastened to tapered track link 165A. Upper flat surface 240 may be entirely flat, or may include curved or protruding portions. A tapered track link surface 236 of track link 165A may be configured to contact outer tapered surface 222 during operation of machine 100. In some aspects, tapered track link surface 236 may be angled with respect to upper flat surface 240, to a horizontal axis Y-Y defined by bushing 234 within a through hole (not shown) of first tapered track link 165A, or to axis X-X (FIG. 3) of front idler 145 when tapered track link surface 236 is in contact with outer tapered surface 222.

In some aspects, an angle of inclination formed by the taper of track link surface 236, as measured in an outward direction, may be about 1° to about 10°, or 2° to about 5° and may have the same magnitude as first angle 250 (FIG. 3). In other aspects, the angle of inclination formed by tapered track link surface 236 may be greater than or less than first angle 250 (FIG. 3). Tapered track link surface 236 may cause a thickness of track link 165A to decrease in an outward direction along axis Y-Y.

Second tapered track link 165B, including second tapered track link surface 238 and flat surface 242, may mirror the structure of first tapered track link 165A. Like first tapered track link 165A, second tapered track link 165B may taper in an outward direction along second tapered track link surface 238. An angle of inclination formed by the taper of track link surface 238 may be the same as that described above with respect to surface 236, and may be the same as or different than the inclination defined by second angle 252 (FIG. 3).

While front idler 145 has been described above, as understood, each of the above-described features may be present in rear idler 150. For example, front idler 145 and rear idler 150 may have the same structure and corresponding interactions with tapered track links 165. In other aspects, idlers 145 and 150 may have corresponding structures, but different sizes. For example, angles 250, 252 or heights H1, H2 may be different between idler 145 and idler 150.

### INDUSTRIAL APPLICABILITY

The tapered front idler 145, rear idler 150, and track assembly 155 of the present disclosure can be used in track type machines 100, such as track type tractors, dozers, excavators, and skid-steer loaders. Specifically, tapered idlers 145, 150 and track link assembly 155, in accordance with the present disclosure, can be used to form two track assemblies 105 connected to respective tracks 160 for propulsion of machine 100.

During operation of machine 100, track assembly 105, formed of a series of serially-connected track link assemblies 155, may be driven by sprocket 140 to propel machine 100 in a forward direction, in a reverse direction, and to turn to the left or to the right. Each track 160 may travel along front idler 145 and rear idler 150, with tapered surfaces of track links 165 contacting and moving along tapered surfaces of idlers 145 and 150, as well as tapered surfaces of carrier roller 110A and track rollers 110B.

The disclosed tapered front idler 145, rear idler 150, and track link assembly 155 may facilitate self-aligning functions of track assembly 105. In some aspects, the tapered surfaces of front idler 145 and rear idler 150 may prevent track slippage, including when machine 100 is traveling laterally along a sloped surface. The self-aligning configuration of front idler 145, rear idler 150, and track links 165 may facilitate the removal of flanges on track rollers 110A, carrier rollers 110B, or all rollers of track assembly 105, including front idler 145 and rear idler 150. This may reduce manufacturing cost and allow for use of a single roller design such that all rollers (track rollers and carrier rollers) are identical to each other, reducing costs and facilitating precision forging or other manufacturing techniques for the rollers or other components of track assembly 105.

It will be apparent to those skilled in the art that various modifications and variations can be made to the disclosed tapered idler wheels and track assembly without departing from the scope of the disclosure. Other embodiments of the tapered idler wheels and track assembly will be apparent to those skilled in the art from consideration of the specification and the accompanying figures. It is intended that the specification, and, in particular, the examples provided herein be considered as exemplary only, with a true scope of the disclosure being indicated by the following claims and their equivalents.

What is claimed is:

1. An idler wheel for a track assembly, the idler wheel comprising:
a first end;
a second end, opposite to the first end;
a first outer portion adjacent to the first end;
a second outer portion adjacent to the second end;
an axially inner portion between the first outer portion and the second outer portion;
a first tapered surface on the first outer portion that tapers inwardly towards the axially inner portion from the first end; and
a second tapered surface, adjacent to the second end, that tapers from the second end toward a center of the axially inner portion.

2. The idler wheel of claim 1, wherein the first tapered surface is a flat surface with a constant angle of inclination.

3. The idler wheel of claim 1, wherein the first tapered surface forms an angle of inclination with a horizontal axis about which the idler wheel is configured to rotate, the angle of inclination being from about 1° to about 10°.

4. The idler wheel of claim 1, wherein the first tapered surface forms an angle of inclination with a horizontal axis about which the idler wheel is configured to rotate, the angle of inclination being from about 2° to about 5°.

5. The idler wheel of claim 1, wherein the first tapered surface includes an outer tapered end and an inner tapered end, the inner tapered end having a smaller height as compared to a height of the outer tapered end.

6. The idler wheel of claim 5, wherein an angle of inclination of the inner tapered end is the same as an angle of inclination of the outer tapered end.

7. The idler wheel of claim 1, wherein the axially inner portion connects a wall at an end of the first tapered surface to a wall at an end of the second tapered surface.

8. A track assembly, comprising:
a first track link including:
a first end;
a second end opposite to the first end; and
a first track link tapered surface formed on the second end, a taper of the first track link tapered surface causing a thickness of the first track link to decrease in an outward direction of the first track link; and
an idler wheel including:
a first outer face;
a central portion; and
a first idler tapered surface between the first outer face and the central portion, the first idler tapered surface being configured to contact the first track link tapered surface.

9. The track assembly of claim 8, further including:
a second track link connected to the first track link, the second track link including a second track link tapered surface that tapers in an outward direction of the second track link; and
a second idler tapered surface between a second outer face of the idler wheel and the central portion of the idler wheel, the second track link tapered surface being configured to contact the second idler tapered surface when the first track link tapered surface contacts the first idler tapered surface.

10. The track assembly of claim 9, wherein a taper of the first idler tapered surface and a taper of the second idler tapered surface extend linearly.

11. The track assembly of claim 9, wherein the first idler tapered surface forms a first angle with a horizontal axis about which the idler wheel is configured to rotate and the second idler tapered surface forms a second angle with the horizontal axis, the first angle being substantially equal to the second angle.

12. The track assembly of claim 11, wherein the first angle and the second angle are within a range of about 1° to about 10°.

13. The track assembly of claim 9, wherein the first idler tapered surface forms a first angle with a horizontal axis about which the idler wheel is configured to rotate and the second idler tapered surface forms a second angle with the horizontal axis, the first angle being different than the second angle.

14. The track assembly of claim 9, wherein the central portion of the idler wheel is positioned between the first track link tapered surface and the second track link tapered surface when the first track link is in contact with the idler wheel.

15. A track assembly for a machine, the track assembly comprising:
a first track link having:
a flat surface configured to be connected to a track shoe; and
a first track link tapered surface opposite to the flat surface;
a second track link;
a bushing connecting the first track link and the second track link, the bushing extending along a bushing axis; and
an idler wheel including:
a first outer face;
a central portion; and
a first idler tapered surface between the first outer face and the central portion, the first idler tapered surface forming an angle of about 1° to about 10° with the bushing axis, the first idler tapered surface being configured to contact the first track link tapered surface.

16. The track assembly of claim 15, wherein the second track link includes a second track link tapered surface that opposes the first track link tapered surface in a horizontal direction parallel to the bushing axis, the second track link tapered surface being inclined in a direction that is transverse to a direction of inclination of the first track link tapered surface to contact a second idler tapered surface.

17. The track assembly of claim 15, wherein the first idler tapered surface tapers uniformly along an entirety of a flat surface formed by the first idler tapered surface configured to face the first track link tapered surface.

18. The track assembly of claim 15, further including a second idler tapered surface between a second outer face of the idler wheel and the central portion of the idler wheel, the second idler tapered surface being configured to contact a second track link tapered surface of the second track link.

19. The track assembly of claim 15, wherein the idler wheel is free of flanges located between the first outer face and the first idler tapered surface.

20. The track assembly of claim 15, wherein the idler wheel is free of flanges located outward of the first idler tapered surface.
